(19) United States
(12) Patent Application Publication
(10) Pub. No.: US 2010/0049596 A1
(43) Pub. Date: Feb. 25, 2010

(54) COMPUTER-IMPLEMENTED METHOD FOR THE AUTOMATED CALIBRATION OF AT LEAST ONE COMPETENCE TOPOLOGY OF A POSITION/JOB WHICH IS OCCUPIED AND/OR TO BE OCCUPIED WITH THE COMPETENCE TOPOLOGY OF ONE OR MORE CANDIDATES, AND ARRANGEMENT FOR CARRYING OUT THE METHOD

(75) Inventors: Gudrun Frank, Ottersberg (DE); Dana Janas, Steinbach (DE); Katalin Meszlery, Aachen (DE)

Correspondence Address: VENABLE LLP, P.O. BOX 34385, WASHINGTON, DC, 20043-9998, US

(73) Assignee: Gudrun Frank, Ottersberg (DE)

(21) Appl. No.: 12/282,805

(22) PCT Filed: Mar. 10, 2007
(86) PCT No.: PCT/EP2007/002270

§ 371 Date: Mar. 31, 2009

(30) Foreign Application Priority Data
Mar. 14, 2006 (DE) 10 2006 012 172.4

(51) Int. Cl. G06Q 10/00; G06F 17/00

(52) U.S. Cl. 705/11; 705/7; 715/224

(57) ABSTRACT

The invention relates to a computer-implemented method for automated calibration of at least one competence topology of a position/vacancy which is filled and/or to be filled with the competence topology of one or more candidates, characterised by the following steps: a) carrying out a requirement analysis with regard to the competence fields which are required and/or desirable for the position which is filled and/or to be filled, b) converting the data of the requirement analysis determined in step a) into digital data, c) generating at least one competence topology for the position which is filled or to be filled to fix the competence level, d) preparing a position-specific, individual inquiry sheet or inquiry sheet set, e) filling out the inquiry sheet or inquiry sheet set by the candidates, wherein inquiry of the data is effected by means of electronic data transfer, f) data evaluation and generation of a candidate-specific competence topology, and g) assessing the candidate-specific competence topology and calibration of the same with the competence topology of the position/vacancy which is filled or to be filled, wherein steps b), c), d), f) and g) are executed automatically in computer-assisted manner. Furthermore, the invention relates to an arrangement for carrying out the method.

The invention relates to a computer-implemented method for automated calibration of at least one competence topology of a position/vacancy which is filled and/or to be filled with the competence topology of one or more candidates. Furthermore, the invention relates to an arrangement for computer-implemented calibration of at least one competence topology of a position/vacancy which is filled and/or to be filled with the competence topology of one or more candidates.

Personnel and personal employment planning, that is inter alia the recruiting of new personnel and internal personnel development, is of particular importance for the success of a business, of an organisation, of a college, of administrative establishments and other concerns. In personnel planning of a concern, for example when filling new vacancies/positions, when refilling existing vacancies/positions within the framework of internal re-structuring and when releasing personnel, it depends quite considerably on selecting the correct candidate or the correct candidates from a number of candidates. It should thus be taken into account that certificates, degrees or the like are only suitable to a limited extent to permit conclusions for suitability. Rather, the abilities, competences of a candidate for requirement-related action in situations are decisive for the efficiency or suitability of candidate employment.

Therefore on the one hand with regard to the competence fields which are required and/or desirable for the position to be filled or positions to be filled and positions which are filled, that is the position-specific competence topology (THEORETICAL value), within the framework of a requirement analysis must be determined. On the other hand it is to be determined whether and to which extent the candidates fulfil the selected competence fields or have the competences, that is, which competence topology they have (ACTUAL value). The determination of the ACTUAL value is also designated as competence measurement.

Expressed differently, the invention relates to a method and an arrangement for analysis for generating a competence topography formed from several competence topologies for businesses, concerns, organisations and the like as the basis of a process for selecting suitable candidates using the competence topology of the position. Conventionally, several competence fields or competences are required and/or desirable for each position/vacancy. Differentiation is thus made between various competence fields. For example team orientation, ease of communication, loyalty, sense of responsibility and open-mindedness are mentioned as core competence, critical and conflict faculty, encouragement of talent, willingness to delegate, ability for achievement and trustworthiness as management competence, and flexibility, ability to solve problems, reliability, ability for cooperation and ability for organisation as position-specific competence. The said and further competences can be subdivided in turn into various further competences. For example, secondary competences, such as for example ability for teamwork, ability for dialogue etc. are behind the umbrella term social competence. The linking of the competences is complex and is also designated as “parent-child system”.

Furthermore, it depends of course also crucially on the specialist competence and other method knowledge which are structured in the same manner. In practice, the requirements, that is the desirable and/or required competences and competence fields which a candidate or several candidates must bring with them, are usually defined by a person on the basis of experience and personal assessment. The complexity and integral view of this person is characterised subjectively by the selective perceptive and decision-making behaviour.

In order to select the candidates or to determine the competences thereof, a number of known processes exist, such as for example employment questionnaires, performance tests, work samples, behaviour observation, standardised interviews and other methods. Hitherto it is conventional that certain competence fields and competences are tested or measured in each case only using one process. Hence, personnel advisers, personnel developers or other people responsible for the area of personnel carry out a subjective assessment of the applicants/candidates, and assess according to personal standards the results, for example of interview notes or questionnaires or work samples.

The current processes have various disadvantages. Particularly problematical and therefore full of errors are however, firstly the generation of sound requirement profiles and secondly the measurement of the competence of the candidates. A common problem thus consists in that the result, that is the generation of the requirement profile and the result of competence measurement depends decisively on the abilities and experiences of the assessing person.

Expressed differently, the current practice is based rather on a random principle. The methods currently known are very cost-intensive, particularly for personnel recruiting due to the high expense in terms of time and the conventionally required personnel expense when sifting through candidates or carrying out assessment processes. Furthermore, the problem exists that the traditional methods are extremely time-consuming. For example it is quite possible that several hundred applications have to be investigated, tested and evaluated. The success rate is correspondingly low. A further problem is the suitability. The so-called matching quality in the known methods is low, since the competence fields are divided only into generic umbrella terms, such as for example the above-mentioned social competence. Competences are also measured spanning departments. Vacancy and/or department-specific requirements thus remain unconsidered.

From the above-mentioned statements regarding current practice in personnel selection and/or personnel reassignment, it becomes clear that both in the vacancy description and in the selection of suitable candidates, considerable deficits exist which prevent optimum, that is suitable filling of vacancies/positions.

It is therefore the object of the present invention to propose a reliable, rapid and reproducible method for selecting suitable candidates for a position to be filled. Furthermore, an object of the invention consists in providing a device for carrying out the method.

This object is achieved by a method having the following steps: a) carrying out a requirement analysis with regard to the competence fields which are required and/or desirable for the position which is filled and/or to be filled, b) converting the data of the requirement analysis determined in step a) into digital data, c) generating at least one competence topology for the position which is filled or to be filled to fix the competence level, d) preparing a position-specific, individual inquiry sheet or inquiry sheet set, e) filling out the inquiry sheet or inquiry sheet set by the candidates, wherein inquiry of the data is effected by means of electronic data transfer, f) data evaluation and generation of a candidate-specific competence topology, and g) assessing the candidate-specific competence topology and calibration of the same with the competence topology of the position/vacancy which is filled or to be filled, wherein steps b), c), d), f) and g) are executed automatically in computer-assisted manner. Using this computer-assisted step sequence of the invention, it is possible for the first time to carry out objective generation of the competence topology or competence topography which is on a broad base and close to reality on the one hand and the competence measurement (generating the competence topology of the candidates) on the other hand. Due to computer-assisted implementation, firstly generation or calculation of competence topologies and measurement of competence which is independent of people (personnel developers, management forces etc.) is possible. Secondly, the generation or calculation of competence topologies and the measurement of the competence may be carried out much more precisely, because almost any number of components may be included in the consideration. In addition to the improvement of the success rate due to the input-output measurement, a considerable shortening of the selection times is also guaranteed. A further advantage of the method of the invention lies in the fact that for the concerns, businesses etc., optimisation of existing resources may be carried out. Due to the method of the invention, any number of topologies of competences which form a topography are taken into account, wherein the topologies can be derived synthetically from the cases, cultural elements and links in a position, a business, an organisation etc. A further advantage consists in the fact that objective long-term monitoring of competence measurements is possible, and specifically independently of the supervising/managing personnel. A further significant advantage of the method of the invention lies in the temporal monitoring of the inquiry process. If for example the candidate will fill out the inquiry sheet or the inquiry sheet set without consideration and reflection, this may be subjected to a plausibility test and calculated as a mistake.

In addition to the advantages described further above for the employer side, that is the concerns, businesses etc., the method of the invention also offers advantages for the employee side. Hence, the quality of the personal marketing (“market value”) may also be improved transparently and measurably by means of the method. Using the results of the method of the invention, one's own career planning can also be individualised and improved in a target-directed manner.

The object is also achieved by an arrangement which is characterised by the following features: an electronic apparatus for filling out inquiry sheets or inquiry sheet sets, wherein the apparatus is designed to register the answers itself, the time for filling out and the sequence of filling out, a first evaluating unit for the information collected by the inquiry sheets or inquiry sheet sets with corresponding memory modules, a second evaluating unit for executing mathematical methods, and a third evaluating unit for converting digital data into readable evaluating forms, wherein all components of the arrangement are in functional connection with one another. The advantages already described further above can be achieved using this arrangement.

Further advantageous or preferred features and method steps can be seen from the sub-claims and the description. The method of the invention and a suitable arrangement are illustrated in more detail using the attached drawing. In the drawing:

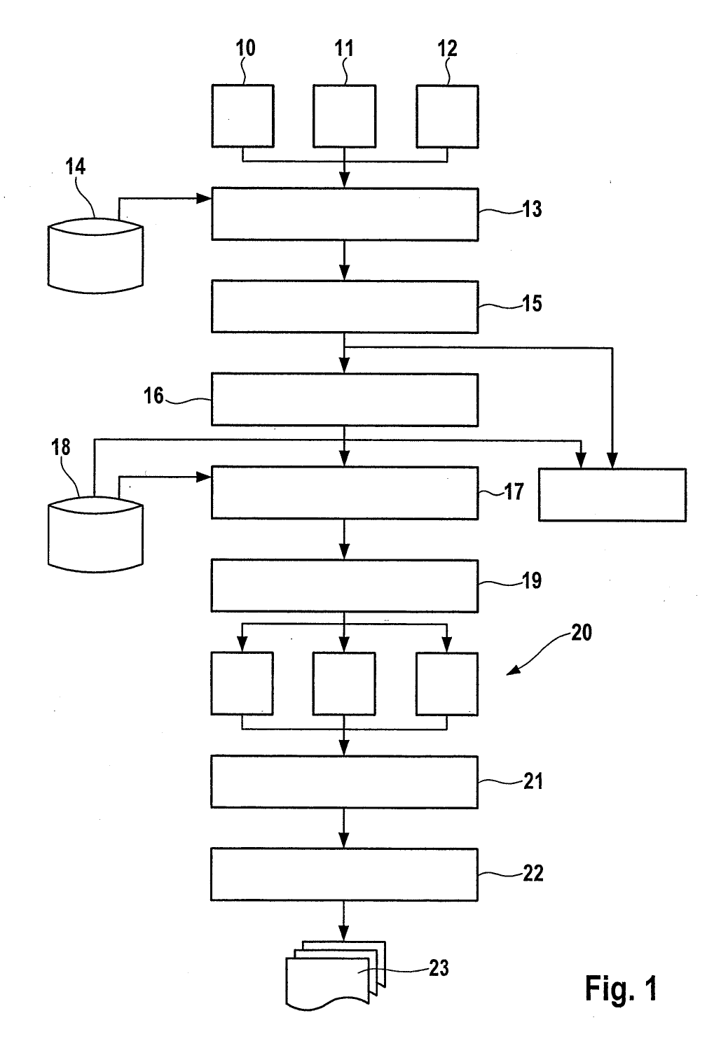

FIG. 1 shows a schematic representation of the computer-implemented method from carrying out a requirement analysis to preparing a position-specific, individual inquiry sheet or inquiry sheet set,

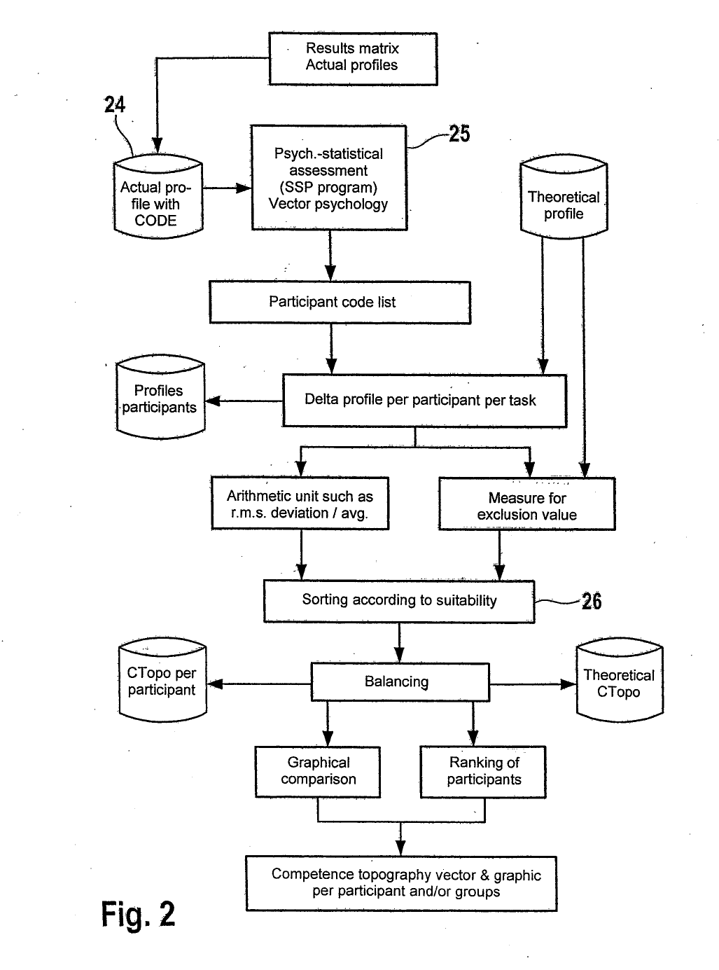

FIG. 2 shows the continuation of the schematic representation according to FIG. 1, namely starting with the results matrix recovered from the inquiry sheets or inquiry sheet sets,

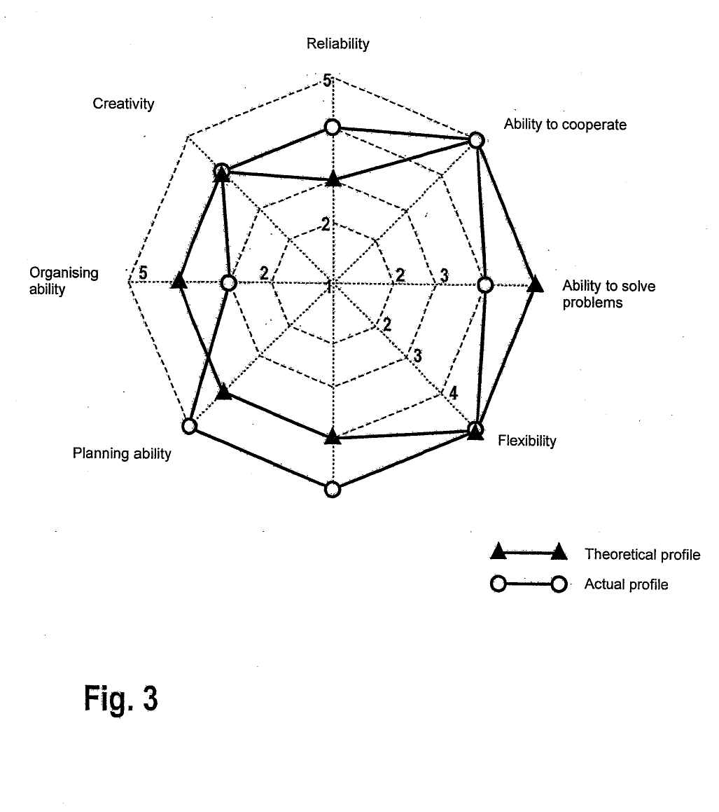

FIG. 3 shows a results matrix or suitability matrix with a THEORETICAL-ACTUAL comparison, and

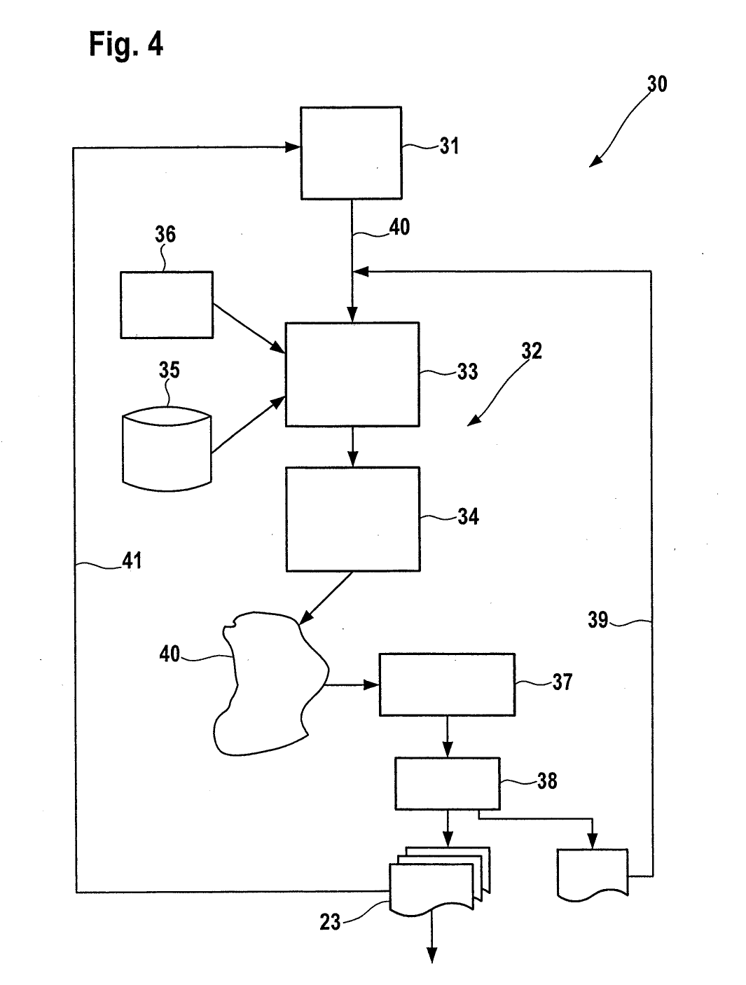

FIG. 4 shows a schematic representation of the arrangement for carrying out the method.

The invention relates to a computer-implemented method for automatic balancing of at least one competence topology of a position/vacancy which is filled and/or to be filled with the competence topology of one or more candidates and an arrangement for carrying out the method.

When filling one or more open vacancies or when reassigning vacancies, suitable candidates often have to be chosen from a number of applicants which are particularly suitable for the special vacancy. A first prerequisite to be able to select the suitable candidate or candidates is the carrying out of a requirement analysis with regard to the competence fields which are required and/or desirable for the vacancy/position to be filled. Each vacancy/position has its peculiarities and features, namely a special topology.

In other words, it is to be determined which competences the candidates have to bring with them for the vacancy/position in order to be able to fulfil it in optimum manner. Expressed differently, the generation of a competence topology for the position which is filled and/or to be filled is determined synthetically via a competence code. The concerns, businesses or other vacancy-advertising establishments thus have standardised inquiry sheets, inquiry sheet sets, forms or the like which are produced from a special material, such as for example special paper. They are preferably case forms 10, culture-registration forms 11 and process-registration forms 12. These forms 10 to 12 are continuously updated, namely validated, in that experiences and knowledge from expert interviews flow into the concerns/businesses or for competitors/rivals, from the literature, from observation, from requirement and occupation analyses for exemplary employment fields and positions and other areas.

The standardised forms 10 to 12 are then filled out by the concerns/businesses etc. using an electronic pen or the like, so that the forms 10 to 12 or the contents thereof are converted into digital data. At least one requirement profile to fix the competence level is then generated from these data automatically and in computer-assisted manner. An individual inquiry sheet is generated from existing standard modules for this synthetically composed competence topology of a position. Expressed differently, an individual inquiry sheet or inquiry sheet set is generated using the data determined. Generating the or each requirement profile comprises initially in module 13 the generation of the data determined and transformation of the same into competence features. The competence features are coded and held and stored in a memory 14 in so-called component data store. So-called competence codes are filed in the corresponding memories 14 and/or databases for the composition of certain competences.

A validation data store or validation module are filed in the subsequent module 15. Furthermore, module 15 is suitable to execute mathematical analysis processes, such as for example statistical calculations. The validated and analysed competence features are then stored in module 16. The information/data is then compressed in module 17 and a current and individual competence topography is generated. Questionnaire features or various known and suitable methods stored in memory 18 are thus taken into account for measurement/assessment of the competence features. Module 19 then selects the information/data/methods required for generating an individual questionnaire or questionnaire set and puts them together to form an inquiry document sample. The inquiry document sample is subdivided into different competence fields 20, such as for example core competence, management competence and position-specific competence. From these competence fields 20, a final inquiry document structure, which is also designated as “competence DNA”, is then formed in module 21. The selected questions, tasks, sketches etc., which have been shown to be relevant for this special topology, are compiled by means of a questionnaire generator, a random generator, corresponding random processes or the like. Using suitable means, for example a printer 22, the final individual inquiry documents in the form of inquiry sheets or inquiry sheet sets 23 may be generated automatically and distributed to the candidates.

Due to this compilation, the inquiry sample has a book form with various chapters which make it no longer possible for the candidate to recognise which question/task/sketch etc. is linked to what, as a result of which the quality of the registered competences is ensured. So-called sample monitoring, which infers something from the response or filling-out behaviour, is thus ruled out. Furthermore, the vocabulary, terms etc., which are conventional for a particular line of business are used, which is assisted by the applied parent record. The sequence just described from filling out the forms 10, 11 and 12 to generation of the inquiry sheets or inquiry sheet sets 23 for the candidates is effected automatically in computer-assisted manner, so that subjective influences are almost ruled out. Due to the central intermediate storage of data and information in the corresponding modules and/or memories, the data/information can be used again or be utilised for developing the method.

Individual candidates or groups of candidates may now fill out the inquiry sheets or inquiry sheet sets 23 matched exactly to the vacancy/position to be filled. They thus preferably use an electronic pen or the like. By filling out using the electronic pen or the like, in addition to the answers, the sequence and/or the duration of response of the individual tasks or questions are also registered. The data and information determined regarding the individual candidates form an ACTUAL profile which is stored centrally in a memory 24 after coding.

A psychological and industrial-science assessment of the ACTUAL profile is then effected by means of a module 25, wherein the assessment is carried out using calculation processes of vector psychology and statistics (SPSS). A profile code list, the so-called competence topology for each participant, is produced from the assessment. After sorting the suitability of the individual candidates in module 26, balancing takes place between the competence topologies of the candidates on the one hand and the competence topology of the position which is filled and/or to be filled. The calculation of suitability serves to assist the efficiency of selection. Due to the extent of suitability and the so-called slippage (tolerance of admissibility of exceeding and falling short of the level values which is determined by a separate mathematically defined process. Independently of how extensive the required competence fields are, this slippage is adapted, but calculated in standardised manner.), only the candidates are automatically proposed which fulfil the suitability. This balancing is prepared graphically and leads to vector graphics, as shown in FIG. 3. The client makes the final selection of the candidate or candidates.

FIG. 3 shows an example of a THEORETICAL profile for a vacancy to be filled. For this vacancy, the competences reliability, ability for cooperation, ability to solve problems, flexibility, ability to plan, ability for organisation and creativity are of particular importance. However, the said competences also have a different weighting on a scale of 1 to 5, wherein 1 means a low weighting and 5 means a very high weighting. The THEORETICAL profile is the result of the requirement analysis. The ACTUAL profile as a result of competence measurement shows in the example that a few requirements (for example ability for cooperation) are fulfilled exactly. Other requirements are not fulfilled (for example ability to solve problems) or over-fulfilled (for example ability to plan).

The method described may be used in recruiting new personnel and/or in personnel development. In the case of use in internal personnel development, process steps e) to g) may also be executed repeatedly with one candidate or several candidates to be able to exactly determine, for example a development path. The stored data/information from the earlier processes thus form the basis.

FIG. 4 shows once again a base arrangement 30, which is designed and suitable both for generating the competence topology of the position/vacancy which is filled and/or to be filled and for generating the position-specific, individual inquiry sheets or inquiry sheet sets and for generating the candidate-specific competence topology. Even if the base arrangement 30 or individual elements of the same concur with the elements, for example of FIG. 1 (FIG. 1 shows in detail the elements for generating the position-specific, individual inquiry sheets or inquiry sheet sets), the individual elements of the base arrangement 30 according to FIG. 4 have been provided with separate reference numbers for the sake of a better overview.

The arrangement 30 comprises electronic means 31, apparatuses, pens or the like, which are designed for electronic registration of answers, the time for responding and the sequence of responding. These means 31 are in functional connection with a central computer 32 via WLAN, point-to-point transmission, for example by mobile radiocommunications or other suitable communication lines and/or communication media 40. The central computer 32 comprises a first evaluating unit 33 and a second evaluating unit 34. Memories 35, databases 36 or the like may be assigned to the or each evaluating unit 33, 34. The central computer 32 is connected via the Internet, WLAN or the like to a third evaluating unit 37, which may be positioned decentrally. A printer 38 or the like is assigned to the third evaluating unit 37. In a first cycle of the arrangement 30, the standard forms 10, 11, 12 filled out by the businesses, concerns, organisations etc. are analysed, evaluated and prepared. As a result of the first cycle, the or each competence topology is fixed for the position which is filled and/or to be filled, which are then presented to the business, the concern or the like for checking. After final matching via the competence topology of the position which is filled and/or to be filled, the or each competence topology of the arrangement 30 is supplied again (see arrow 39). By means of the arrangement 30, the position-specific, individualised inquiry sheet or inquiry sheet set 23 is then prepared on the basis of the competence topologies for the position which is filled and/or to be filled. The inquiry sheet or inquiry sheet set 23 is then supplied to the candidate (see arrow 41), who fills out the inquiry sheet or inquiry sheet set 23. Again means 31 are thus used. By means of the arrangement 30, the competence topology of the individual candidates is then determined or calculated from the answers of the candidates. The scheme shown in FIG. 3 and already described further above is then produced by the balancing of the competence topologies.

1.-20. (canceled)

21. Computer-implemented method for automated calibration of at least one competence topology of a position/vacancy which is filled and/or to be filled with the competence topology of one or more candidates, characterised by the following steps:
a) carrying out a requirement analysis with regard to the competence fields which are required and/or desirable for the position which is filled and/or to be filled,
b) converting the data of the requirement analysis determined in step a) into digital data,
c) generating at least one competence topology for the position which is filled or to be filled to fix the competence level,
d) preparing a position-specific, individual inquiry sheet or inquiry sheet set,
e) filling out the inquiry sheet or inquiry sheet set by the candidates, wherein inquiry of the data is effected by means of electronic data transfer,
f) data evaluation and generation of a candidate-specific competence topology, and
g) assessing the candidate-specific competence topology and calibration of the same with the competence topology of the position/vacancy which is filled or to be filled, wherein
steps b), c), d), f) and g) are executed automatically in computer-assisted manner and in steps c) and d), the digital data of the requirement analysis are generated and transferred into competence features, wherein in step c), suitable methods for measuring/assessing the competence features are selected from a stored component data store and due to step c), the competence topology designated as THEORETICAL profile is generated for the position which is filled or to be filled.

22. Method according to claim 21, characterised in that in step a), requirement and occupation analyses for exemplary employment fields and positions are carried out.

23. Method according to claim 21, characterised in that in step a), expert interviews are carried out in the business, in which the position is filled or to be filled, and/or in competing businesses.

24. Method according to claim 21, characterised in that in step a), standardised forms for case registration and/or for culture registration and/or for process registration are filled out.

25. Method according to claim 24, characterised in that the forms are filled out using an electronic pen or a corresponding means.

26. Method according to claim 21, characterised in that the component data store is validated continuously.

27. Method according to claim 21, characterised in that in step e), the sequence and/or the duration of the solution or response to the questions, the tasks, the sketches etc. is registered.

28. Method according to claim 21, characterised in that all information from the inquiry sheet or inquiry sheet set is used to generate the competence topology of the or each candidate and stored centrally as an ACTUAL profile.

29. Method according to claim 21, characterised in that the competence topology of the position to be filled and the competence topology of the or each candidate are placed one above another graphically for a THEORETICAL-ACTUAL comparison.

30. Method according to claim 21, characterised in that the method is used in the recruiting of new personnel and/or in personnel development.

31. Method according to claim 30, characterised in that in particular for personnel development, steps e) to g) are executed repeatedly with one candidate.

32. Arrangement for computer-implemented calibration of at least one competence topology of a position/vacancy which is filled and/or to be filled with the competence topology of one or more candidates essentially characterised by an electronic apparatus for filling out forms, inquiry sheets or inquiry sheet sets or the like, wherein the apparatus is designed to register the answers itself, the time for filling out and the sequence of filling out, a first evaluating unit for the information collected by the inquiry sheets or inquiry sheet sets with corresponding memory modules, a second evaluating unit for executing mathematical processes, and a third evaluating unit for converting digital data into readable evaluating forms, wherein all components of the arrangement are in functional connection with one another.

33. Arrangement according to claim 32, characterised in that the functional connection via mains power lines, radio signals or other connecting/communication lines are connected to one another.

34. Arrangement according to claim 32, characterised in that a printer for printing out the results data is assigned to the third evaluating unit.

35. Arrangement according to claim 32, characterised in that it is designed for automated generation of competence topologies for the position which is filled and/or to be filled.

36. Arrangement according to claim 32, characterised in that it is designed for automated generation of the inquiry sheets or inquiry sheet sets to be filled out by the candidate or candidates.

37. Arrangement according to claim 32, characterised in that it is designed for automated generation of one or more candidate-specific competence topologies.
